(19) United States
(12) Patent Application Publication
(10) Pub. No.: US 2015/0142508 A1
(43) Pub. Date: May 21, 2015

(54) INCIDENT PLAYBOOK GENERATED IN REAL TIME FROM DISASTER RECOVERY PLAN EXTRACTIONS

(71) Applicant: SunGard Availability Services, LP, Wayne, PA (US)

(72) Inventors: Francis Buck, Warminster, PA (US); Patrick Olivares, Malvern, PA (US); Bhuvana Sundaresan, Exton, PA (US); Derek Bluestone, Collegeville, PA (US); Gary Cohen, Radnor, PA (US)

(73) Assignee: SunGard Availability Services, LP, Wayne, PA (US)

(21) Appl. No.: 14/086,345

(22) Filed: Nov. 21, 2013

(51) Int. Cl. G06Q 10/06

(52) U.S. Cl. CPC G06Q 10/0635
USPC 705/7.28

(57) ABSTRACT

Systems, methods and procedures enabling an incident planner to build and distribute disaster response playbooks to be used by incident responders. Information is excerpted from multiple plan documents (such as disaster recovery, crisis management, business continuity, or emergency response plans) that includes only what are the essential personnel contacts, tasks, and resources needed at time of disaster.

### BACKGROUND

1. Technical Field

This patent application relates to a data processing system that provides an incident plan design environment for extraction of essential information to an incident playbook. The system supports dynamic generation and real time dissemination of essential information to incident responders, such as the first responders to a disaster.

2. Background Information

Enterprise risk management is an increasingly critical consideration in any business. Recent catastrophic events such as hurricanes Katrina and Sandy in the United States, and the earthquake with resulting tsunami in Japan, have shown that any organization is exposed to potentially catastrophic loss. The ability to swiftly recover critical business processes and information technology infrastructure during such crises is essential to mitigating economic loss. It is therefore now common for most any enterprise of significant size to develop plans to deal with various types of crises. These plans can include Business Continuity (BC), Disaster Recovery (DR), Crisis Management (CM), Emergency Response (ER) and other plans. Any given business may have multiple such plans, depending on the businesses in which it engages, different plans for different operations and departments, different plans for the different types of physical facilities it operates, for different physical locations, and so forth.

These risk management solutions typically rely on outputs that generally take the form of one or more printed or digital version of a plan document. The plan documents are intended to be distributed as action guidelines for members of recovery team.

The documents often must also have other sections to serve certain purposes used for internal corporate policy, external audit, and/or regulatory compliance. For example, in the case of financial institution, it may be necessary to include numerous sections to detail compliance with regulations such as Sarbanes-Oxley. In the case of a healthcare facility, these plans may need to have detailed specifications for complying with medical data protection laws such as HIPAA. While these pieces of each plan are extremely important for ensuring that the enterprise complies with applicable regulations and the law, they have no particular bearing on what actually needs to be done at the time of a crisis.

Unfortunately, the needed compliance information appears to be “boilerplate” from the perspective of emergency responders, rendering most of the content of such plans someone unhelpful for determining the actual steps needed to be taken at the time of a disaster (ATOD). This static content is therefore only consulted during such internal audits or regulatory compliance, and not during an emergency as it contains much information that is not pertinent to the recovery team's actual action plan.

Additionally, if more than one plan needs to be consulted and activated, recovery team members are faced with having to review all of the plans in their entirety. These compliant plans sometimes exceed 200 pages or more in length, far too much reading to expect to be undertaken in a crisis. Indeed, our informal polling has shown that at the time of a crisis, approximately 70% of recovery teams members do not use the plans at all, believing them to be too complex. Emergency personnel therefore simply do not have time to consult such plans for guidance at the time of a disaster.

Consider a situation where an impending hurricane is forecast for the businesses operation. An incident planner and/or other administrative personnel at a business begins to become alarmed when they see or hear a local weather report. The planner will have to now consider a series of plans. The enterprise may for example, be a nationwide securities firm that has a business continuity plan. The BC plan details and how to keep the retail store front in Boston open during bad weather. But the planner must also consider an Information Technology (IT) disaster recovery plan that details a set of procedures for how to, for example, enable a backup data center located at a remote site in West Virginia to start replicating data stored at the office in lower Manhattan that houses the stock traders' data processing equipment. The administrator might also have to consider a crisis management plan that spells out policies and procedures for communicating with first responders, medical personnel, members of the press, and so forth.

The situation is further complicated by the fact that a business with a presence in more than one location typically needs a set of crisis plans device for its facilities in different cities. The Philadelphia office, which also has IT systems, may have similar but not exactly the same procedures as Manhattan for IT disaster recovery.

In all of these situations the administrator and/or upper management of the enterprise are primarily concerned with operational resilience. To achieve the best possible result, disaster recovery teams should know exactly what do at the time of disaster, to minimize downtime, and bring the business back up as quickly as possible. Within a typical enterprise, configuration information for these settings is spread across multiple documents. Recovery procedures are also quite susceptible to frequent changes, which are difficult to transmit among responsible emergency personnel.

### SUMMARY

Described here are systems, methods and procedures to capture, format and process information needed for orderly collection, extraction, and dissemination of information that is essential to an enterprises' disaster response. In one aspect, a data processing workbench environment enables creation of an incident playbook data element. The incident playbook becomes a repository for essential and/or relevant excerpts extracted from each of several plans. These excepts become a “plan for the moment” to help govern the response of an enterprise to a crisis situation. The incident playbook is effectively a new plan which is a digest of only the essential operational details of the response.

A given enterprise may, as a result, develop multiple incident playbooks, each one having different attributes and each one designed from the perspective of, and intended for use by, different response teams, and to different types of events. For example, one incident playbook may be for use in recovering data processing systems in an IT department after failure of a data center, another may be used by a human resources department to keep all employees informed as to when their office space will be open again after a major winter storm, and yet another one for a marketing operation to reopen a remote retail sales location after a fire.

The incident playbook thus enables the incident planner to design a real-world plan containing only the information relevant at the time of need to a particular class of responders. The incident playbook becomes in one sense a derivative work of multiple, lengthy recovery plans, highlighting only the most important steps to be carried out immediately after a crisis event. These may include, for a specific response team:
Who do we contact as essential team members?
How do contact these members?
What other resources do we need immediately?
What do we need to do as the essential next steps?
How do we communicate with outside emergency responders?

In addition, each type of disaster scenario requires different responses. A response to a hurricane will likely be different than a response to a power outage. Therefore it would be preferred if such plans could be crafted in advance of a specific event type, depending on the disaster event type.

In particular implementations, the workbench environment enables an incident planner or other administrative user to create a digest of essential information taken from multiple plans that relate to a specific disaster scenario. The incident planner can select portions of plan documents, bring them into the workbench environment, and arrange them in a suitable way for the enterprise depending on the type of incident. As a result, instead of such response personnel having to dig through different pages of different plans, they have a defined set of tasks to perform and other information resources at their fingertips immediately. The incident playbook functionality thus allows incident planners to select only the relevant information needed by each team at the time of disaster to complete the recovery, while suppressing information only needed for the purpose of internal audit or external regulators.

The incident planner can also designate an appropriate channel or channels by which the essential information will be communicated. For example email, text messaging, instant messaging, and other standards-based electronic communications mechanisms may be specified.

As a result the workbench and incident playbook paradigm transforms crisis plan activation into a real-time, dynamic mechanism for testing or actual disaster recovery. They permit identification of the vulnerabilities that matter, to guide the next best action, and to better accommodate change, resulting in improved resiliency when a disaster strikes.

### BRIEF DESCRIPTION OF THE DRAWINGS

The description below refers to the accompanying drawings, where:

FIG. 1 is a high level work flow for a workbench environment used to generate and distribute an incident playbook from plan documents;

FIG. 2 is a more detailed example data processing environment;

FIG. 3 is an example of data objects that represent the playbook; and

FIG. 4 is a user interface that an incident planner may use to review a list of source plans;

FIG. 5 shows a plan overview user interface screen with extracted metadata from plan documents;

FIG. 6 illustrates a user interface allowing the incident planner to further develop the incident playbook for a Call Center;

FIG. 7 illustrates a list of different locations that may be included in the Call Center incident playbook;

FIG. 8 is a detailed example of the types of team information associated with the playbook;

FIG. 9 is an interface that may be used by the incident planner to further confirm aspects of the playbook to record maintenance tasks;

FIGS. 10 and 11 are example interfaces illustrating information that may be displayed once the playbook is designed;

FIGS. 12A and 12B are an example report for the Call Center listing event-specific information, such as employees by location and department and a list of processes arranged by Recovery Time Objective;

FIG. 13 illustrates an extension to the user interface to allow the incident planner to access a set of predefined report types; and

FIG. 14 illustrates a interface that may be presented to enable the incident planner to create custom reports.

### DETAILED DESCRIPTION OF AN EXAMPLE EMBODIMENT

According to one specific implementation, a data processing system enables specification, display, and distribution of elements of an incident playbook. The incident playbook specifies people, places, processes and tasks pertinent for an enterprise to use in responding to an incident, such as a disaster. Data objects for the playbook are collected from a number of plans such as disaster recovery (DR), crisis management (CM), business continuity (BC), and emergency response (ER) and placed into a common data structure such as a relational database. Information is then extracted from the plans and stored as database objects. An incident planner may manually create these plan extracts or these plan extracts may be captured automatically from the source plans. The extracted information is then further arranged for a given type of incident, for given operation, into an incident playbook specific to the incident and operation. Links to updated information are maintained as the attributes of data objects change over time. The incident playbook information is then distributed to incident responders, at the time of the incident, with updated information in real time.

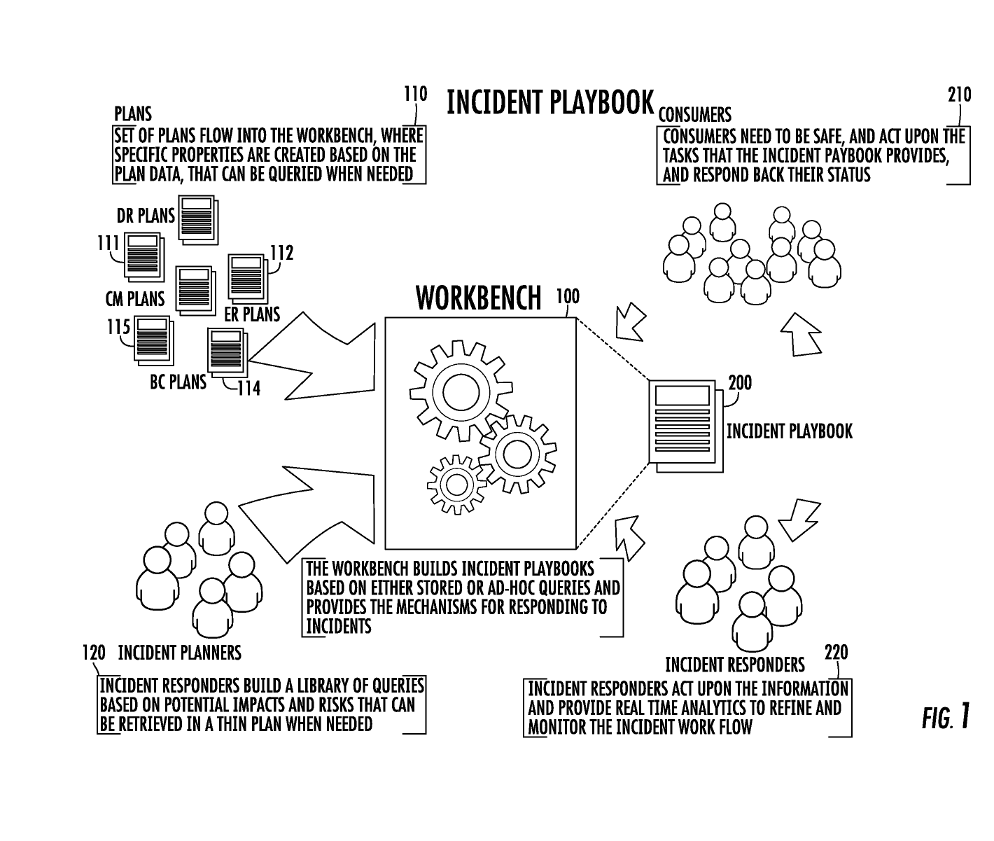

FIG. 1 is a high-level conceptual diagram of an incident playbook environment 100 that enables incident planners to design a unified plan in the form of an incident playbook 200 that includes information relevant to a class of incident responders at the time of a disaster. The environment 100 enables an incident planner 120 to develop the incident playbook 200 as a derivative work of pieces taken from a number of different plans 110. The playbook 200 is an effective abstract of the aspects of one or more plans 110 deemed essential by the incident planner 120. The incident playbook 200 excludes information that is not considered essential for the incident responding at the time of disaster. The indident playbook 200 may include a list of tasks, essential personnel and their contact information, a list of resources needed, locations affected, and the preferred communication mechanisms for the emergency response team.

Distribution of the incident playbook 200 information is performed in real time upon demand to incident responders 220 and/or consumers 210 as described in more detail below.

The workbench environment 100 permits a incident planner 120 to be presented with, and to select parts of any number of stored plans 110 to be included in the incident playbook 200 tailored for a specific incident. The incident playbooks 200 thus represent an extraction of the most coherent set of instructions and essential information possible.

FIG. 1 illustrates a typical workflow in the example workbench 100 environment. The workbench 100 is implemented using one or more data processors that accept text inputs in the form of plans 110 and user inputs in the form of instructions from incident planners 122, to generate one or more incident playbooks 200. The incident playbooks 200 are then reviewed and consulted by consumers 210 and/or incident responders 220 in connection with determining what to do in the event of a disaster or other unexpected occurrence.

The plans 110 may originate from various sources. They may include disaster recovery (DR) plans 111, emergency response (ER) plans 112, business continuity (BC) plans 114, crisis management (CM) plans 115 or other types of disaster, emergency, contingency, business risk mitigation, or other similar types of plans. These plans may originate in a number of different forms but are typically a highly detailed set of printed specifications for how an enterprise should react to a disaster. The plans 110 are provided in the form of a human readable electronic document such as a .PDF, .DOC or other suitable format.

The content of these plans 110 may include a list of key activities, personnel and resources required to implement an effective crisis response strategy.

However such plans 110 also include quite a bit of additional information such as current state assessments, risk based assessments, identified critical risks, suggestions to eliminate or reduce risks, business impact analyses, and comparison of recovery strategy options, suggestions for facilitating tests to ensure orderly recovery, and so forth.

Such plans 110 may also include compliance information relevant to the enterprise in hand. For example if the enterprise is a financial institution, it may be required to include in its disaster procedures a number of compliance elements as promulgated by various member organizations such as the National Futures Association, a national government such as the United States Securities and Exchange Commission, and so forth. In a case where the enterprise delivers medical services, it may need to exhibit compliance with medical data security regulations such as the Health Insurance Portability and Accountability Act (HIPAA), and/or state or local public health regulations or laws.

It can therefore be understood that these plans 110 typically contain a wealth of information that the enterprise must access from time to time. However it becomes quite difficult for individual incident responders 220 to interpret and react to all of the information contained in all of the possibly relevant plans 110 to distill it down to what is essential at the time of an actual disaster.

To that end, the workbench environment 100 enables incident planners 120 to access the plans 110, taking excerpts therefrom, and developing further information to be placed in incident playbook 200. The incident playbook 200 is then made accessible to the incident responders 220 as well as consumers 210. The workbench 100 enables the incident planners 120 to build a library of queries based on potential impacts and risks that can then be retrieved in the “thin plan” represented by the incident playbook 200.

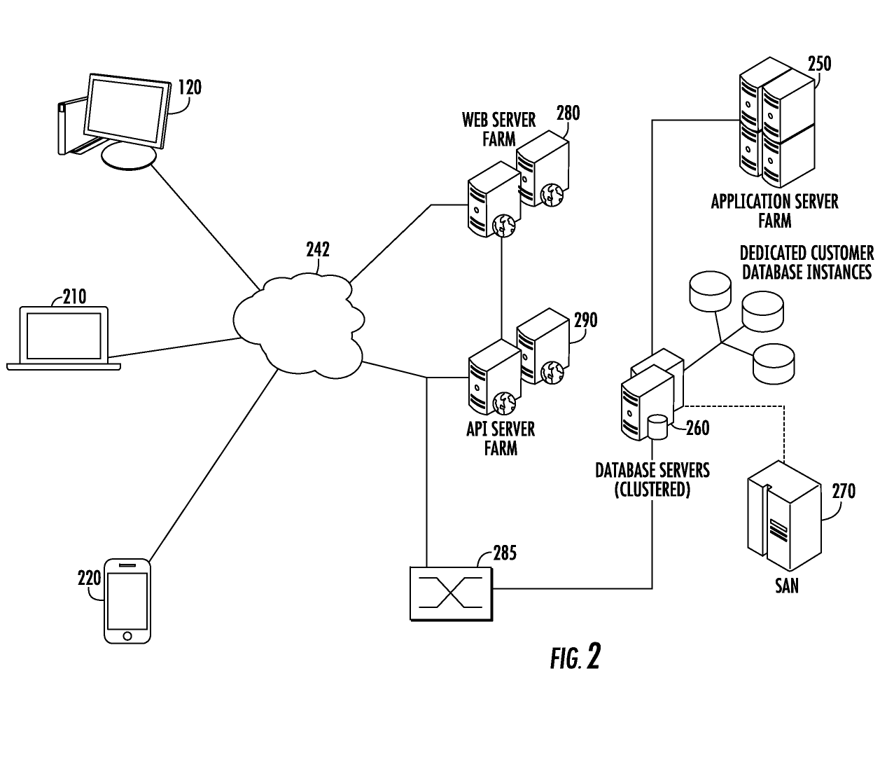

FIG. 2 is a more detailed view of one preferred embodiment of the technical solution provided by various data processing resources used to implement the workbench 100 and incident playbooks 200. In this example, the workbench environment 100 is provided by one or more application server data processors 250 that are accessible over a network infrastructure 242 via personal data processors such as desktop computers, laptop computers, and mobile devices used by the incident planners 120, incident responders 220 and consumers 210. It is understood that the data processing machines including laptop or desktop computers used by incident planners 120, smart phones or tablets used by incident responders 220 and/or consumers 210, data processors 250, file systems database 260, SANs 270 are connected to one another by one or more computer network infrastructure elements 242, 285 which may be implemented as local area networks, wide-area networks or other networks such as the Internet, although the specific form of the network architecture is not important.

The servers 250 store and access information of various types. This information includes the plans 110 stored in the form of the text of an electronic document or other suitable form. The source plans 110 may for example be stored in a file system accessible to the data processors 250 locally via a database server 260 and/or via remote storage devices such as storage area network 270. The incident planners 120 develop data representing a definition of the incident playbooks 200 as a data structure stored also accessible by the data processors 250. In one implementation, the incident playbooks may be stored in the form of a relational data objects accessed via a database server 260. The data objects stored in an example playbook will include extracts taken from the one or more source plans 110 as selected by the incident planners 120. The playbook data is also stored as for example structured data object in a database 260.

The data processors 250 may also store or access queries that enable incident planners 120, customers 210, and incident responders 220 to access the structured data extracts stored in the incident playbooks 200.

Incident planners 120 may also specify to the data processors 250, as part of the incident playbook design process, a specific distribution mechanism for the information in the incident playbook 200. This distribution information is then used to disseminate critical information to the incident responders 220 and consumers 210 at the time of disaster via optional infrastructure such as web servers 280. Custom applications may also access via incident playbooks 200 via Application Programming Interface (API) servers 290. Thus additional optional infrastructure elements such as web servers 280 and API servers 290 may serve as front end processors for the back end processors represented by application server 250, database server 260, and SAN 270. In such an arrangement, it may be advantageous for security purposes to include internetworking device(s) 285 such as switches, routers, and firewalls to manage message flow.

The data processing elements of FIG. 2 thus enables selection of key aspects of information taken from multiple source plans 110, distilling it down to essentials and storing it, and then later distributing it a preferred channel of delivery to the incident responders 220 such as via a mobile application, a text message, a webpage or the like. In addition, the information in the incident playbook 200 can be generated in real time and updated as the people, processes, events, and locations associated with particular incidents changes over time. The information presented to the consumers 210 and the incident responders 220 is therefore dynamically representative of these changing relationships.

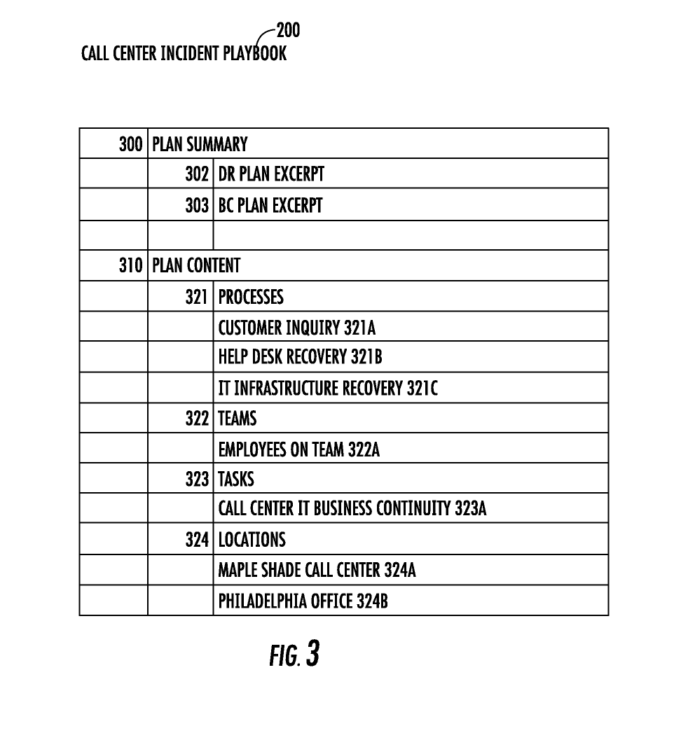

FIG. 3 shows an example incident playbook 200 data object in more detail. Here is shown an example of the information taken from across multiple plans to provide a playbook 200 associated with particular a particular type of event. In the illustrated example, the event was a flood at a call center in eastern Pennsylvania. Information examples concerning critical personnel, locations and tasks are illustrated as having been taken from a business continuity plan 114 and a disaster recovery plan 111. Other information taken from a BC plan 114 specifies how the information technology resources are to be recovered at the disaster recovery site.

The Call Center incident playbook object 200 includes a number of data objects such as a plan summary object 300 and plan context object 310. The plan summary object 300 may further include a first data object 302 which is a plan excerpt; in this example, that is a text excerpt from the disaster recovery plan 111. A second data object 303 is a text excerpt from the business continuity plan 114.

As explained previously these excerpts 302, 303 may be stored as text and graphic information extracted from various plans 110. The data objects may include the text and graphic excerpts directly as a copy of the source data. But the objects may also be links such as uniform resource locators or other identifiers for locating the source text information from the plans 110.

Another object in the incident playbook 200 is a plan content object 310. Plan content object 310 may further include objects such as processes 321, teams 322, tasks 323 and locations 324.

In the example shown the processes further include a customer inquiry process 321A, a helpdesk recovery process 321B, and an IT infrastructure recovery process 321C. These processes 321A, 321B, 321C have been extracted from various plans 110. For example, helpdesk recovery process 321B may be taken from a business continuity plan 114 whereas the IT infrastructure recovery process 321C may have been taken from a disaster recovery plan 111.

The teams object 322 may consist of a list 322A of employees by location and department that are essential personnel for the processes 321 that must be carried out at the Call Center.

The tasks object 323 may include a list of tasks that are pertinent to call the call center that were extracted from the business continuity plan 114 for the call center.

The locations object 324 may include information relating concerning the different physical locations that are implicated by the incident playbook 200; here these include the Maple Shade Call Center 324A and the Philadelphia 324B location.

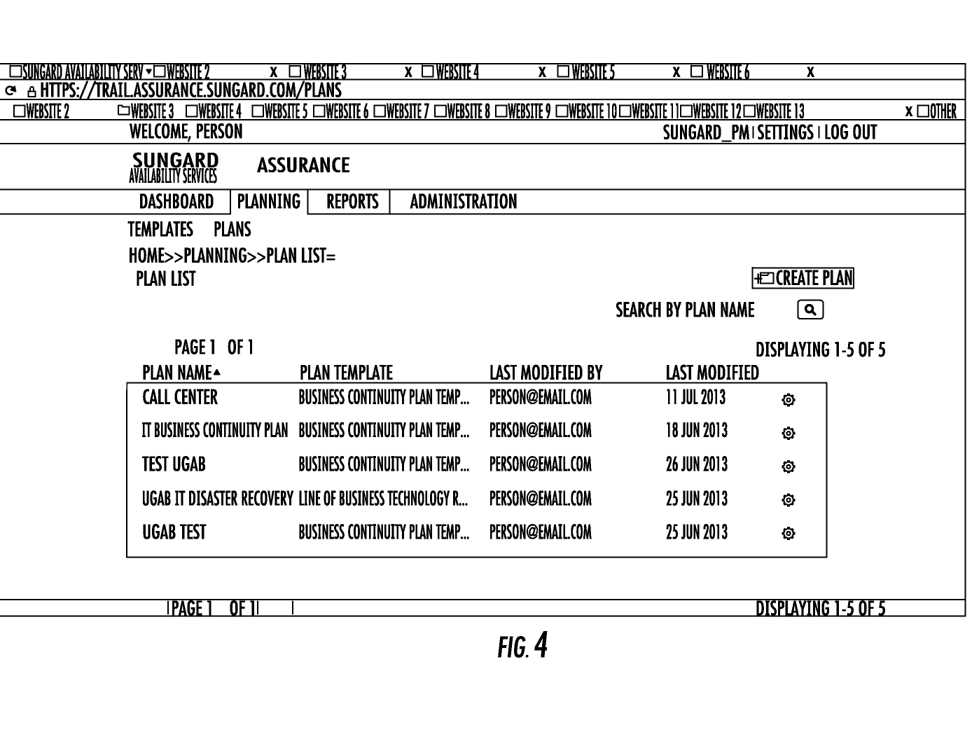

FIGS. 4 through 14 are example screenshots of various aspects of the graphical user interfaces (GUI) used by the incident planner 120 interacting with the workbench 110 to devise the incident playbook 200.

The first screen of FIG. 4 is a view that the incident planner 120 may use to a review a list of source plans 110 that have been imported. For example this list may include DR plans 111, ER plans 112, BC plans 114, and CM plans 115 in the form of PDF or DOC document files.

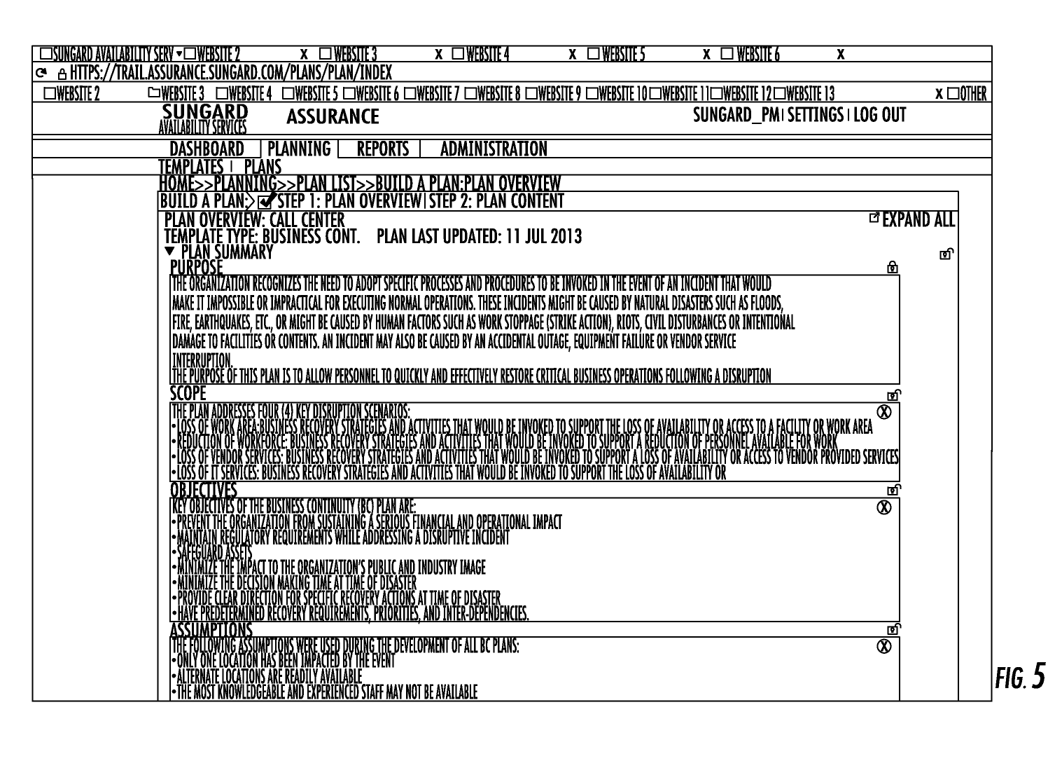

As shown in FIG. 5 the plan documents 110 have also been processed to extract metadata from them and stored as data objects. In this example a particular business operation, a call center, is to have a plan designed for responding to crises. In this example the objects include a plan summary section that states the purpose of the plan, the scope of the plan, the plan objectives and assumptions of the plan. This view is exemplary of the type of information which is not germane at the time of disaster but is absolutely needed in a source plan 110 for compliance with regulatory and/or legal requirements for certain types of enterprises.

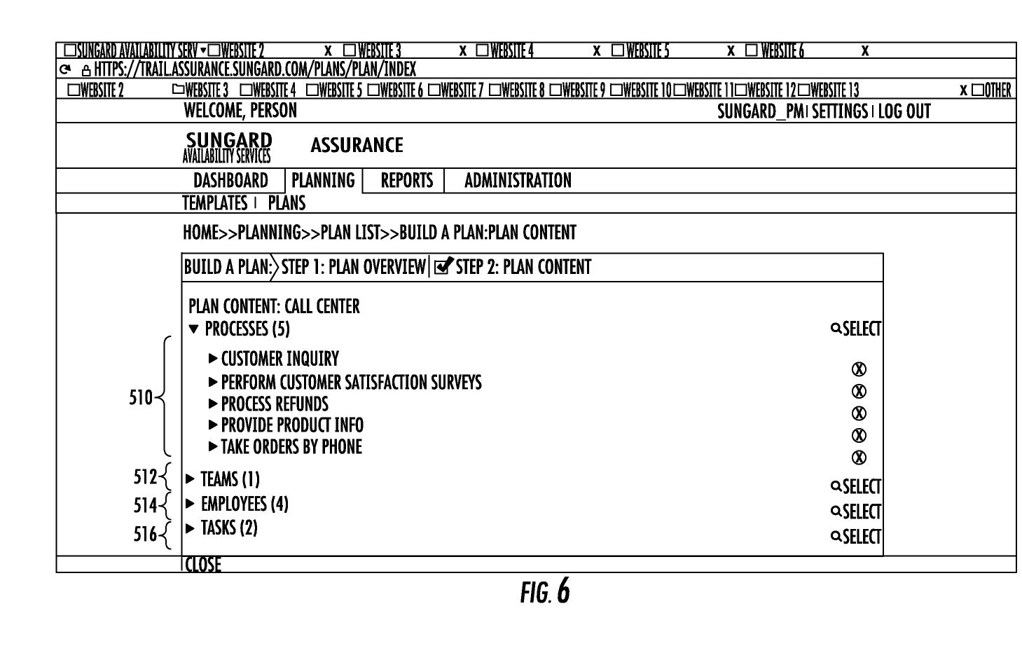

FIG. 6 illustrates a screen that may be presented to the incident planner 122 to further develop the incident playbook for the call center. Here the incident planner 120 can specify essential business processes that are to be recovered 510, a list of personnel who are members of the recovery team 512, and a set of tasks 516 to be carried out by the team. It should be understood that the class of personnel would be different for other types of incident playbooks. For example, if the incident playbook 200 is a plan for recovery from a fire at a data center, the personnel may include information technology specialists as well as emergency primary responders such as firefighters.

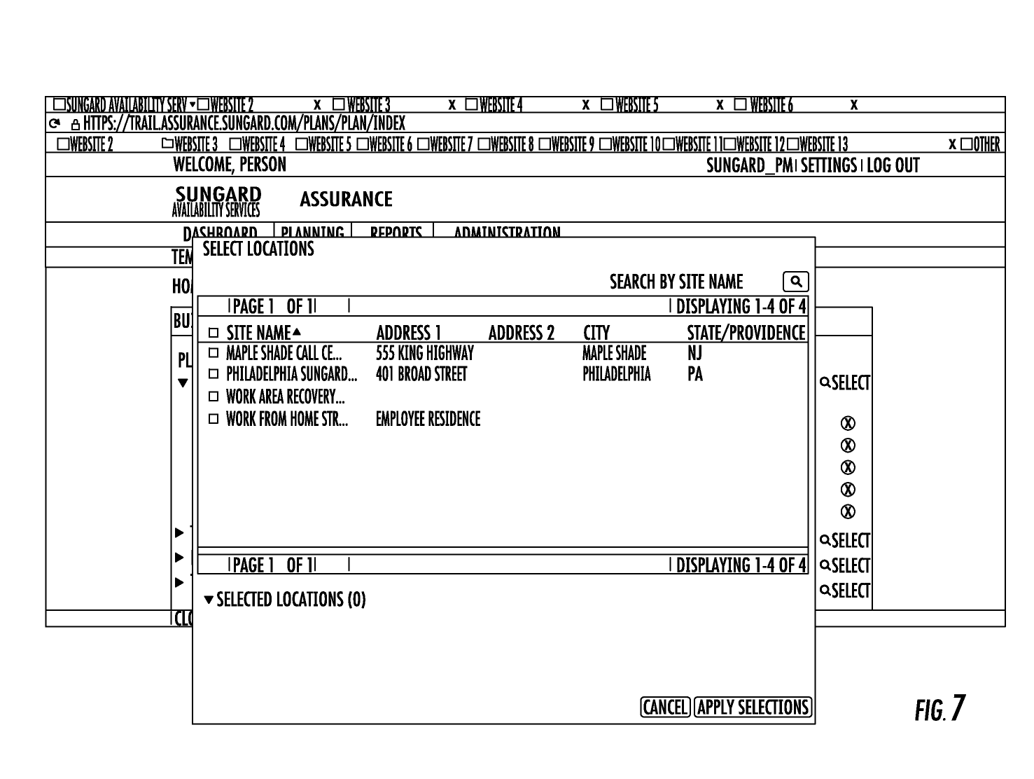

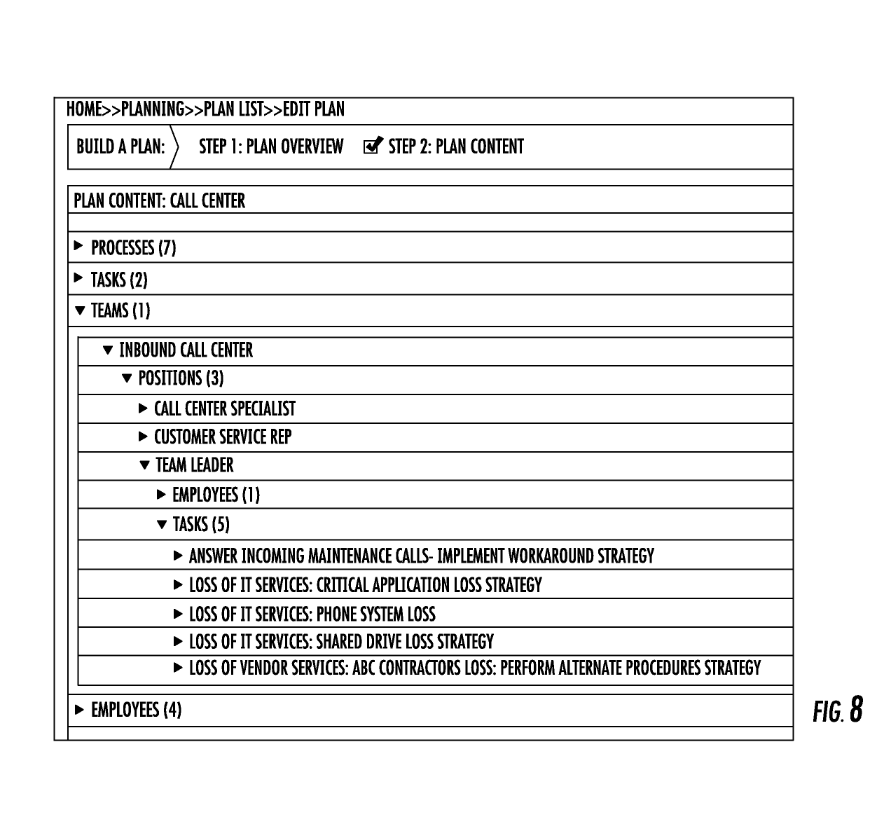

It is possible that the plan overview may also include additional attributes in the playbook 200 such as the different locations as shown in FIG. 7 which may be necessarily affected by the plan. FIG. 8 shows a detailed example of the types of team information that may be associated with the playbook 200 for the call center. Here, the call center has a single team identified as the “inbound call center” which has three essential roles including two employees in the “call center specialists” function and one employee in the “team leader” function.

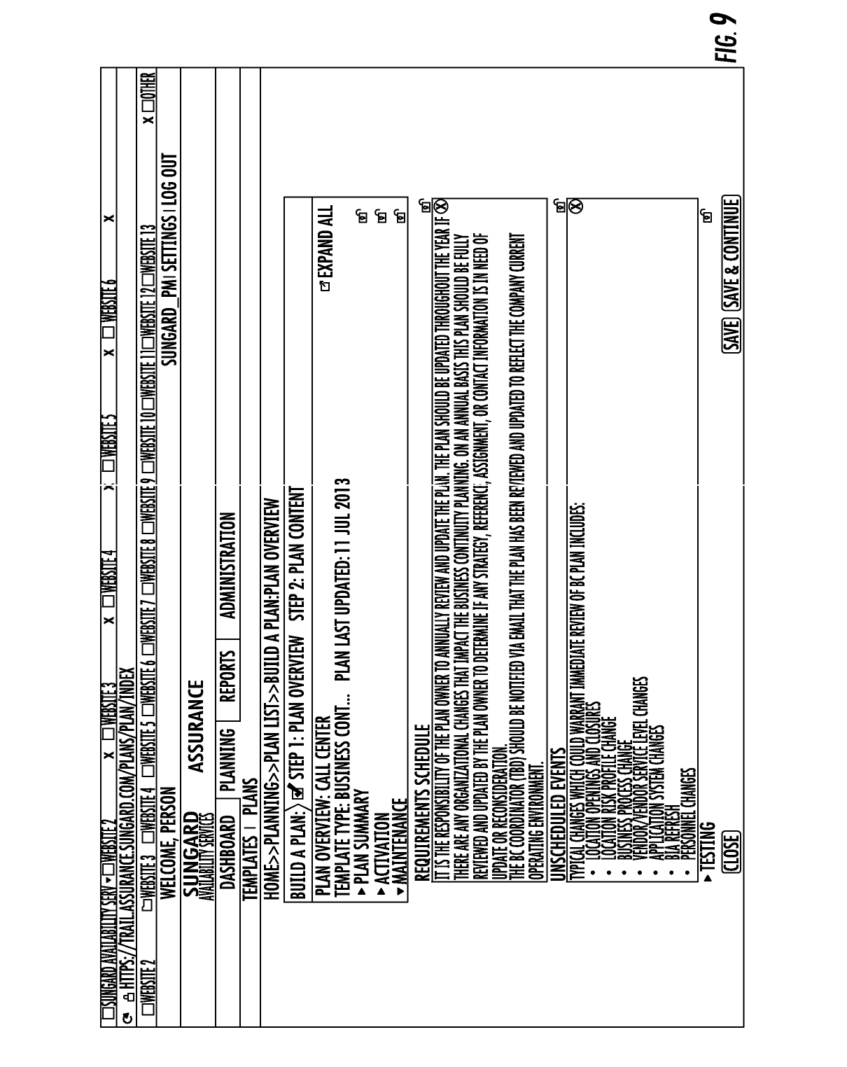

FIG. 9 is an example screen that may be viewed by the incident planner 122 to further confirm aspects of the playbook in order to define tasks that must be carried out in order to maintain the incident playbook. These may be dictated by the organization or associated with regulatory or audit compliance requirements.

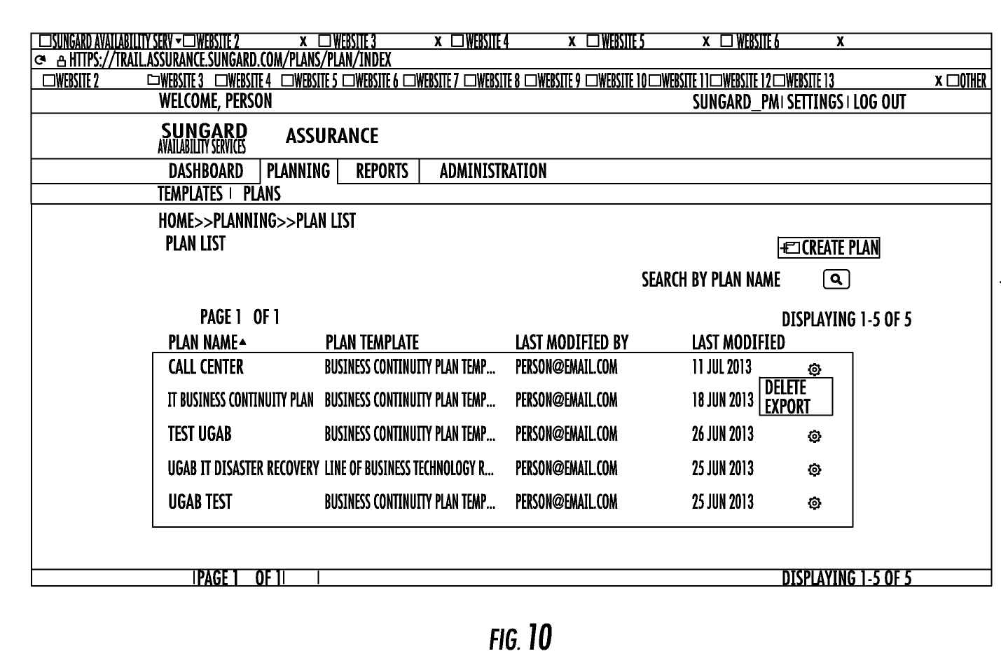

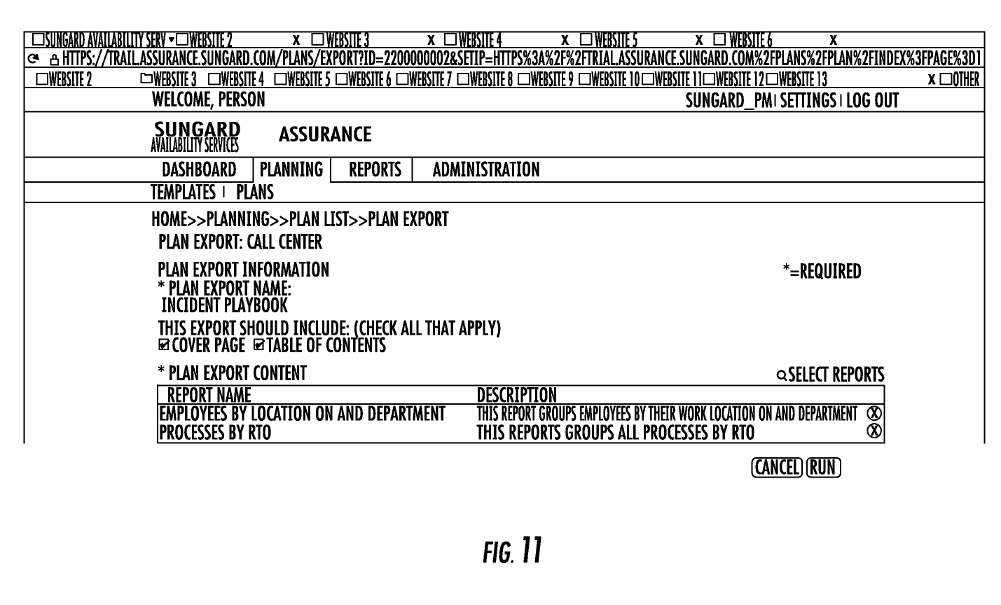

FIGS. 10 and 11 are examples of that information that can then be exported from the incident playbook 200 and displayed once the playbook is designed. Returning to a screen such as that shown in FIG. 10, the incident planner 120 can now see that he has defined a playbook 200 for the call center as a “business continuity plan template”. An IT business continuity plan, a test VGAB plan, a UGAB IT disaster recovery and a UGAB Test incident playbook have also been created.

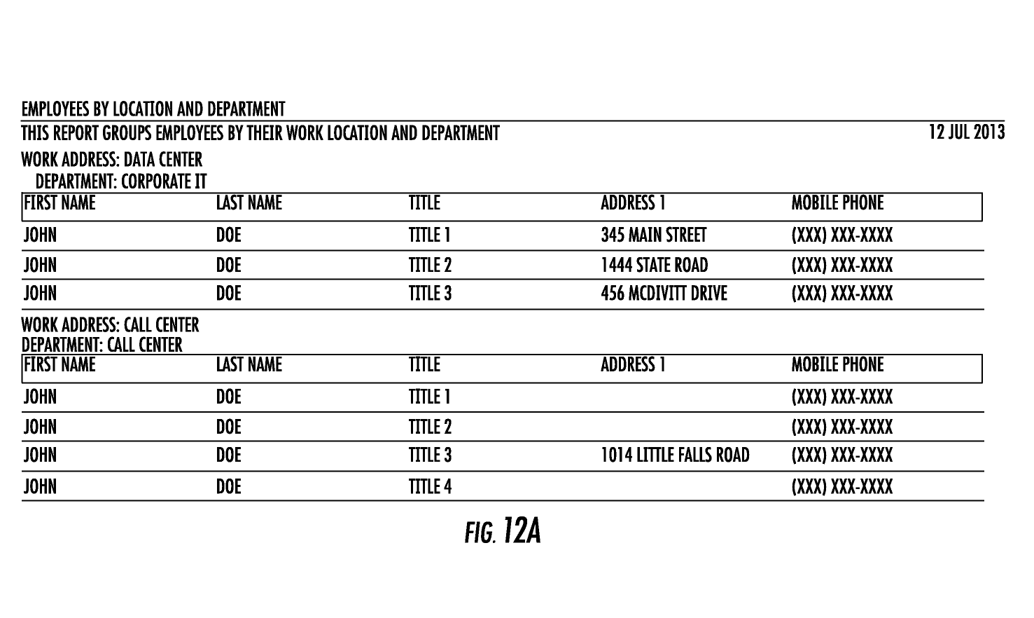

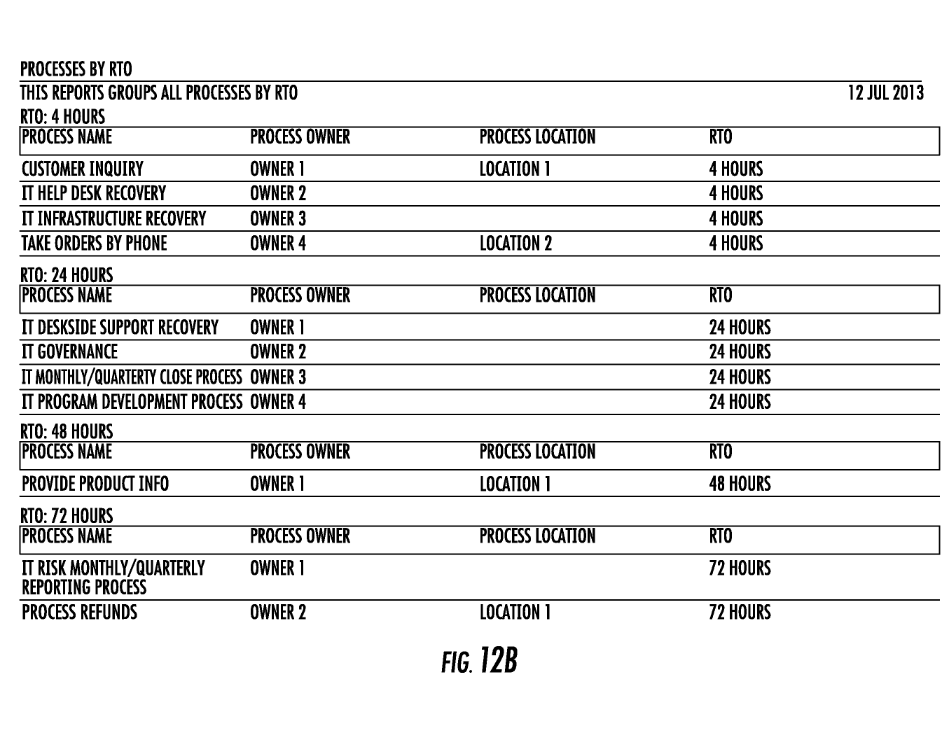

In FIG. 11 the incident planner is requesting export of information from the Call Center incident playbook 200. Here the extracted information is taking the form of a report that includes a cover page and a table of contents. The remaining content includes a list of employees by location and department, and the processes that are necessary to be carried out arranged by recovery time objective. The “employees by location and department” data is an example of germane information that was taken from the elements of various plans 110 in the process of developing the data objects included in the incident playbook 200 associated with this event. The report thus generates a complete list of all employees by different location department necessary to carry out desired recovery plan. This report and/or other reports may then be generated and stored as for example a PDF file. The reports may take a form as shown in FIG. 12A as for example the list of employees by location and department, and FIG. 12B showing the requested list of processes arranged by Recovery Time Objective duration.

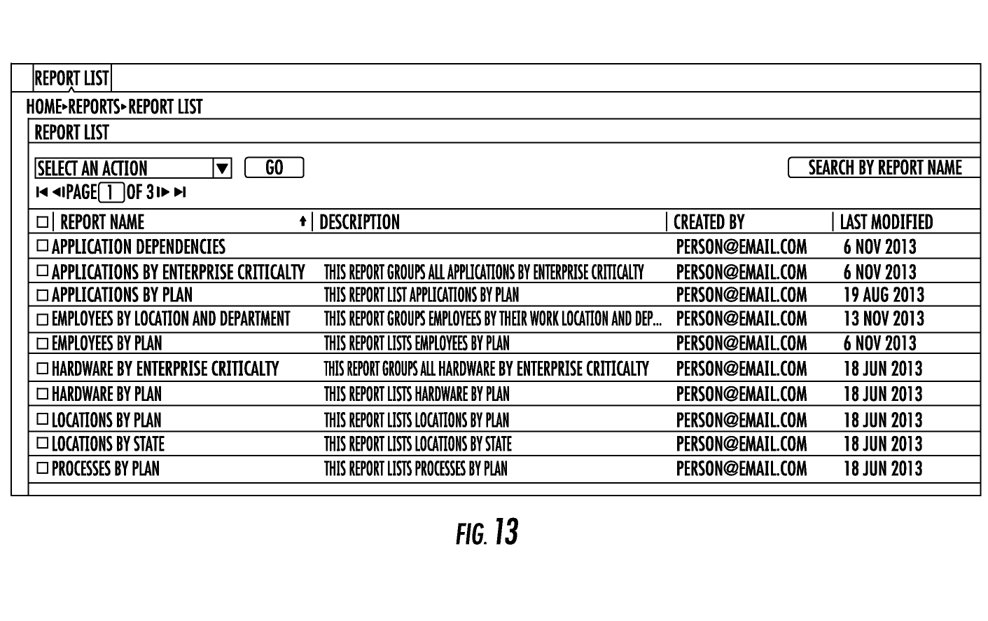

It should be understood that various extensions to the screens may also be provided. For example, in FIG. 13 the incident planner 120 may access a set of predefined report types.

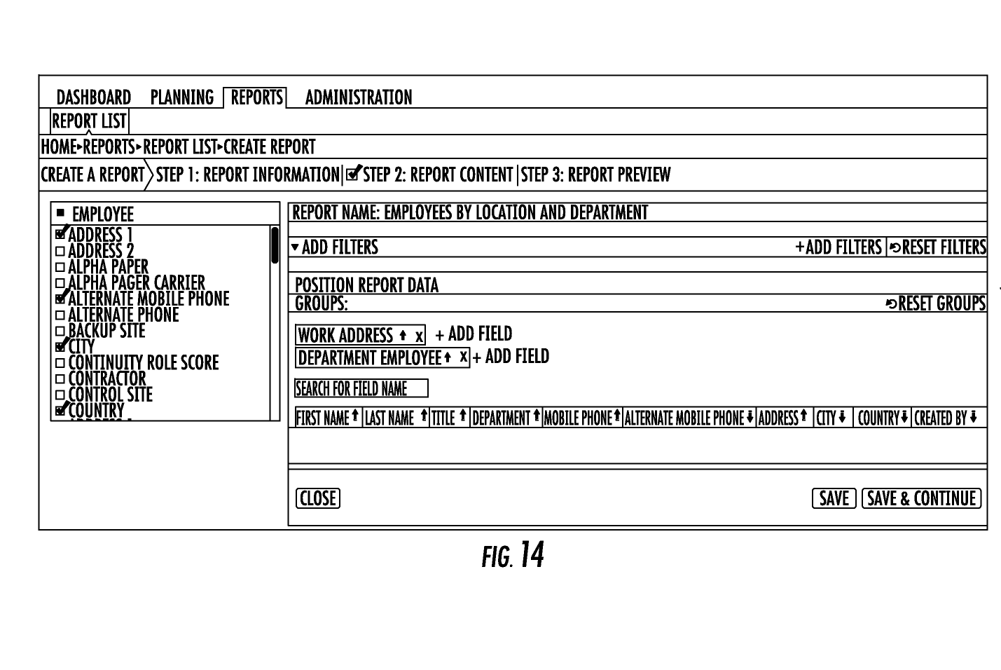

However a function such as that shown in FIG. 14 may also be presented to the incident planner 120, enabling them to create a custom report (in this instance, by selecting attributes of employee information filters and the like).

### Implementation Options

It will be understood that the data processing elements such as the servers, file systems, and databases described herein may further include infrastructure elements that are not shown, such as other types of physical networking equipment such as routers, switches, and firewalls, or other data processing equipment such as servers, load balancers, storage subsystems, and the like. The servers may include web servers, database servers, application servers, storage servers, security appliances or other type of machines. Each server typically includes an operating system, application software, and other data processing services, features, functions, software, and other aspects.

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

While this invention has been particularly shown and described with references to example embodiments thereof, it will be understood by those skilled in the art that various changes in form and details may be made therein without departing from the scope of the invention encompassed by the appended claims.

What is claimed is:

1. A method for an incident planner to specify an incident playbook that contains information pertinent for incident responders to use in response to a disaster event comprising:
extracting information from disaster recovery, crisis management, business continuity, and/or emergency response plans pertaining to the type of disaster;
storing the extracted information as data objects arranged as the incident playbook;
associating event and incident responder specific information with at least one of the objects in the incident playbook;
updating the event and/or incident responder specific information; and
distributing the information in the incident playbook to the incident responders at a time of disaster with the updated information.

2. The method of claim 1 wherein a distribution channel for distributing the information is selectable by either the incident planner or the incident responders.

3. The method of claim 2 wherein the distribution channel is an email message, a short message service message, a mobile application, or a web page.

4. The method of claim 1 additionally comprising:
selecting objects in the incident according to the specific class of incident responder.

5. The method of claim 3 wherein the class of incident responder depends on a role of the incident responder.

6. The method of claim 1 wherein the objects in the incident playbook further comprise one or more of:
a list of tasks to perform at the time of disaster;
a contact list for the incident responders; or
a list of resources needed by the incident responders.

7. A data processing system for maintaining information pertinent for incident responders to use at time of disaster comprising:
user interface software, for operating a server processor to perform the steps of
extracting information from disaster recovery, crisis management, business continuity, and/or emergency response plans pertaining to the type of disaster;
associating event and incident responder specific information with at least one of the objects in the incident playbook;
updating the event and/or incident responder specific information; and distributing the information in the incident playbook to the incident responders at a time of disaster with the updated information; and
a data object storage device, for storing the incident playbook as a set of data objects representing information extracted from the plans.

8. The apparatus of claim 7 wherein the objects in the incident playbook further comprise:
a plan summary object including information take from two or more of the plans; plan content, taken from two or more of the plans; and
information provided for the user interface by an incident planner.
